(19) United States
(12) Patent Application Publication
(10) Pub. No.: US 2019/0180243 A1
(43) Pub. Date: Jun. 13, 2019

(54) PROVISION OF PROFESSIONAL SERVICES

(71) Applicant: PEKAMA LTD., Cambridge (GB)

(72) Inventor: Zeev FISHER, Cambridge (GB)

(21) Appl. No.: 16/276,607

(22) Filed: Feb. 14, 2019

Related U.S. Application Data
(63) Continuation of application No. 15/286,508, filed on Oct. 5, 2016, now abandoned.

(30) Foreign Application Priority Data
Oct. 9, 2015 (GB) GB1517894.0

(51) Int. Cl. G06Q 10/10

(52) U.S. Cl. CPC G06Q 10/103; G06Q 50/18

(57) ABSTRACT

An event-based data storage and analysis system for managing event-based data storage and analysis and a method for the same; the system comprising: a data storage module in which a record is created and in which one or more events relating to a matter are created and stored; and wherein data is stored in the record by associating the data with one or more events, wherein the or each event can be chosen from a predetermined list of events relating to the type of the matter; and an analysis module for analyzing data collected for a type of event for one or more matters to determine information relating to the type of event.

The present application is a continuation of U.S. application Ser. No. 15/286,508 filed Oct. 5, 2016, which claims priority to Great Britain Patent Application No. GB1517894.0, filed Oct. 9, 2015, which is hereby incorporated by reference in its entirety.

### FIELD OF INVENTION

The present invention relates to improvements in or relating to the provision of professional services, particularly but not exclusively in respect of legal services provided by multiple suppliers.

### BACKGROUND OF THE INVENTION

For many years legal services have been provided in a certain traditional way. Consumers or users of legal services (“Legal Consumers”) approach lawyers, who open files for them and keep them in their offices. The lawyers then periodically update the consumers with the progress of their matters and periodically bill them for their time. While many aspects in the service industry have changed dramatically legal services continue to follow this inefficient model.

The objective of the present invention is to change the way in which professional services in general, and legal services in particular, are being delivered and consumed, by using advanced technological capabilities. The present invention presents a revolutionary approach to professional service provision and use, backed by technology that can make a difference to nearly any company in the global economy, regardless of whether the company is a provider, or a consumer of profession services, such as legal services. Although the invention is focused on legal services, it presents an alternative approach in the use of all types of professional services and may well be adapted for other services in the future, such as accounting, real-estate, consultancy on medical regulation and reimbursement, and essentially, any other service which follow a reasonably predictable serious of events and requires the storage of information relating to such events.

The existing way in which legal services are provided generates problems to both the consumers of legal services (“legal consumers”) and the providers of legal services (e.g. lawyers, solicitors, barristers, paralegals, etc., all will herein be referred to as “Lawyers”).

Over the last few years, several markets have been entirely transformed by the implementation of so-called “Multi-Side Platforms” (MSPs) and cloud-based Software as a Service (SAAS) platforms that look at markets from the perspectives of both consumers and vendors, including a provision of a gateway for 3rd party application providers. Where such platforms have succeeded, they have revolutionized the way in which certain services are provided and have changed entire markets, affecting both consumers and vendors, as well as creating entirely new industries of 3^{rd} party applications. An example is automated searches in property registries for property transactions. For patent law, these may include renewal or translation services.

Such a Multi-Service platform has been anticipated in an article by Harvard Journal of Law and Technology, incorporated here by references, which illustrates how IT has helped cross traditional market obstacles, access new markets, create new products and disrupt some old models in other areas.

(http://jolt.law.harvard.edu/articles/pdf/v23/23HarvJLTech259.pdf).

The article continues to suggest that MSPs are the next natural step in the evolution of the legal market, in helping to “unbundle” legal services. An MSP brings together multiple consumers and with multiple attorneys. “Unbundling” reduces the complexity, by allowing for more technical tasks to be automated and increases accessibility, by helping the consumer to find the most suitable service provider quickly and transparently.

A comprehensive MSP has not yet emerged in the legal industry, and a successful one can only emerge if the challenges explained above are properly addressed. It is an objective of the present invention is to provide the first all-encompassing MSP in the provision of legal services.

### SUMMARY OF THE INVENTION

The present invention describes a method and system for the provision and use of professional services, such as legal services.

According to one aspect of the present invention there is provided a method for managing an event-based data storage and analysis system; the method comprising: creating a record in a data storage module, wherein the record relates to a matter; creating and storing in the record one or more events relating to the matter; and storing data in the record by associating the data with one or more events, wherein the or each event can be chosen from a predetermined list of events relating to the type of the matter; and analyzing data collected for a type of event for one or more matters to determine information relating to the type of event.

An implementation may comprise storing the information for future use.

In an implementation the analyzing step further comprises identifying information associated with the type of event, such as statistical data relating to the type of event; timescales associated with the type of event; and costs and fees associated with type of event.

In an implementation the analyzing step further comprises identifying trends relating to the type of event.

In an implementation the analyzing step further comprises evaluating performance.

An implementation may comprise controlling access to the record by granting permissions to one or more users to access data associated with an event; wherein the method comprises: granting first permissions to a first user to access first data in the record; and granting second permissions to a second user to access second data in the record.

In an implementation the storing one or more events includes storing a date for the event, and details of the event.

An implementation may comprise creating a project associated to at least one record or event, wherein a project includes at least a due date, a description of the project, and at least one task associated with the project, wherein said task is associated with at least one user.

In an implementation the project can be created based on a project template previously created in relation to a response to the event.

In an implementation the project template is created by a system administrator and provided to the or each users, wherein the or each user can change the templates.

In an implementation the system administrator defines an association between a template and a types of user, wherein user types can be a consumer of services, a provider of services, or a third party.

In an implementation a project is automatically created, based on a predetermined project template, and automatically launched upon occurrence of a particular event.

In an implementation a user is prompted to decide whether to create a project associated to an event based on a project template.

An implementation may comprise storing files associated with at least one record, event, or project wherein the first user and the second user communicate on matters related to the record, the event, the project or any combination thereof, and said communications are stored with an indication that they are associated to the record, the event, the project, or any combination thereof.

An implementation may comprise creating cost records associated with at least one record, event, or project, wherein said cost record include financial information on money that has been transferred, needs to be transferred or will be transferred between the first user and either the second user or a third party.

An implementation may comprise a first user requesting a quotation, wherein the quotation is associated with a record, an event, a project or any combination thereof and is communicated to at least one of the second user or a third party; wherein, the at least one of the second user or a third party respond by providing a quote and the first party is automatically informed that quotation has been provided; and wherein the first user indicates acceptance or rejection of the quotation.

In an implementation said indication by the first user creates at least one record of a cost or project.

In an implementation first and second users communicate on matters related to the record, the project, the cost, the quotation, the event, or any combination thereof, and said communications are automatically stored with an indication that they are associated with the record, the project, the cost, the quotation, the event, or any combination thereof.

According to a second aspect of the invention there is provided an event-based data storage and analysis system for managing event-based data storage and analysis; the system comprising: a data storage module in which a record is created and in which one or more events relating to a matter are created and stored; and wherein data is stored in the record by associating the data with one or more events, wherein the or each event can be chosen from a predetermined list of events relating to the type of the matter; and an analysis module for analyzing data collected for a type of event for one or more matters to determine information relating to the type of event.

An implementation may comprise a storage module for storing the information for future use.

In an implementation the analysis module identifies information associated with the type of event, such as statistical data relating to the type of event; timescales associated with the type of event; and costs and fees associated with type of event.

In an implementation the analysis module identifies identifying trends relating to the type of event.

In an implementation the analysis module evaluates performance.

An implementation may comprise an access control module for controlling access to the record by granting permissions to one or more users to access data associated with an event; wherein the control module grants first permissions to a first user to access first data in the record; and second permissions to a second user to access second data in the record.

An implementation may comprise a first access interface allowing a first user to access the data with first permissions and a second access interface allowing a second to access the data with second permissions which are not identical to the first permissions.

In an implementation the storing one or more events includes storing a date for the event, and details of the event.

An implementation may comprise creating a project associated to at least one record or event, wherein a project includes at least a due date, a description of the project, and at least one task associated with the project, wherein said task is associated with at least one user.

In an implementation the project can be created based on a project template previously created in relation to a response to the event.

In an implementation the project template is created by a system administrator and provided to the or each users, wherein the or each user can change the templates.

In an implementation the system administrator defines an association between a template and a types of user, wherein user types can be a consumer of services, a provider of services, or a third party.

In an implementation a project is automatically created, based on a predetermined project template, and automatically launched upon occurrence of a particular event.

In an implementation a user is prompted to decide whether to create a project associated to an event based on a project template.

An implementation may comprise storing files associated with at least one record, event, or project wherein the first user and the second user communicate on matters related to the record, the event, the project or any combination thereof, and said communications are stored with an indication that they are associated to the record, the event, the project, or any combination thereof.

An implementation may comprise creating cost records associated with at least one record, event, or project, wherein said cost record include financial information on money that has been transferred, needs to be transferred or will be transferred between the first user and either the second user or a third party.

An implementation may comprise a first user requesting a quotation, wherein the quotation is associated with a record, an event, a project or any combination thereof and is communicated to at least one of the second user or a third party; wherein, the at least one of the second user or a third party respond by providing a quote and the first party is automatically informed that quotation has been provided; and wherein the first user indicates acceptance or rejection of the quotation.

In an implementation said indication by the first user creates at least one record of a cost or project.

In an implementation first and second users communicate on matters related to the record, the project, the cost, the quotation, the event, or any combination thereof, and said communications are automatically stored with an indication that they are associated with the record, the project, the cost, the quotation, the event, or any combination thereof.

### BRIEF DESCRIPTION OF THE DRAWINGS

Reference will now be made, by way of example, to the accompanying drawings to provide a better understanding of embodiments of the present invention. The drawing should not be interpreted to be limitative and dimensions may not be to scale.

FIG. 1 is a block diagram of a system for obtaining legal services, in accordance with an embodiment of the invention;

FIG. 2 is a block diagram of the data management modules, in accordance with an embodiment of the invention;

FIG. 3 is a flow chart of a process for obtaining legal services, in accordance with an embodiment of the invention;

FIG. 4 is a further flow chart of a process for obtaining legal services, in accordance with an embodiment of the invention;

FIG. 5 is a flow chart of a process for providing legal services, in accordance with an embodiment of the invention;

FIG. 6 is a time line showing actions in the provision and use of legal services, in accordance with an embodiment of the invention;

FIG. 7 is a screen shot showing a screen for data entry and analysis, in accordance with an embodiment of the invention.

### DETAILED DESCRIPTION OF THE INVENTION

The present invention relates to a new method and system for the provision and use of professional services, such as legal services to allow arrangements to be made with two or more parties in the provision or use of such services. An embodiment of the invention makes use of an MSP on which various computer programs are run and which include a plurality of computer modules running the computer programs. For the purposes of this invention, a computer may include any type of computing device capable of presenting data to a user, receiving input from said user and transmitting said input to the cloud, in real-time or in certain periods of times when a connection is available. A computer may hence include a PC, a smartphone, a tablet, an internet-connected watch or another wearable device, etc.

Referring to FIG. 1 a system 100 for the provision and use of legal services is illustrated. The system includes normal computer related elements, although only some of those relevant to the invention are shown. The system includes a number of processors each adapted to carry out different functions. One of the most important elements in the provision and use of legal services is the data related to the matter or project. As a result one of the important elements of the present invention is a data storage module 102. The data storage module 102 is capable of receiving data from the data receiving module 104. In addition the data storage module is capable of sharing data by means of the data sharing module 106. Data may be shared via the Internet 108, or other suitable electronic means, with the client computers 110 and legal service provider computers 112. The system includes a permission module 114 which determines the data to be received and shared based on rules stipulated by the client. In this sense, each of the client or the lawyer can be the owner of the legal matter, and the owner of the legal matter has administrator permissions and the right to assign permissions to other users. Such assigned permissions may include permissions a full administer permission, or a limited permission allowing other users to edit or view, or just to view, certain files, certain events, etc. Additional users can be fellow-employees of the client company, the client's lawyer, or fellow-employees in the lawyer company. It can be anyone else as well, so, for example, if the legal matter is a property transaction, the surveyor or the other side's counsel can be awarded certain permissions to see parts of the file.

The permission module 114 includes rules specified by the client indicating what data can be received from legal service providers and what data can be shared with the legal service providers. Where there are multiple legal service providers the permissions may be different. It is the client that controls the permissions and determines who as has access to their data and for what purposes. The matter is controlled by and owned by the client and the legal services providers only have access thereto as provided for by the client.

The system may also include a data analysis module 116, which is used to carry out any analysis of the record, data permissions or any other appropriate data. As will be described in greater detail below the data analysis may include and statistical or trend related determinations as well as the determination of any information which may be useful to the user of the system.

The system may have multiple clients and multiple legal services providers. For a certain matter there may be a single client but there may be one or many legal services providers. Each legal services provider may be implicated in a plurality of different matters for the same or different clients. Each client may have many matters each handled by the same or different legal services providers.

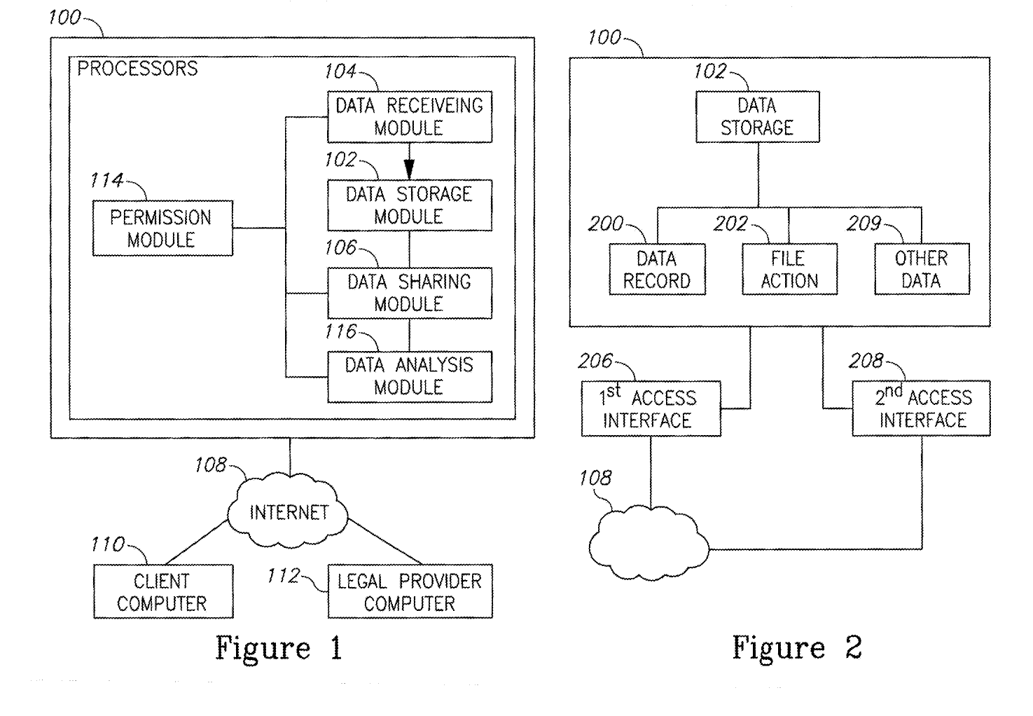

Referring to FIG. 2 the data storage module 102 includes a number of different types of information. By way of example only, these include a data record 200, required actions or events 202, and other types of data 204. First and second access interfaces 206 and 208 respectively may be used to enable access to the data stored in the data storage module by the client and legal services provider respectively. The data record may include all types of information relating to the nature of the matter, the individuals concerned, details of the matter, statutory matters, et cetera. The required actions or events may include a list of necessary tasks that must be carried out within certain deadlines. The actions or events may be needed to complete the matter and may require the input of a legal service provider. The deadline may be a statutory deadline or based on previous deadlines as the case may be. The required actions or events may be linked to a diary system which generates reminders and schedules events. The required actions or events may be linked to a combination of events or actions that must be completed on or before a specific date. The detail contained within the required actions or events field can vary according to the matter concerned and may include any of the above-mentioned information as well as other types of information as appropriate. Other data may include any other information not included in the data record or the required action that is relevant to the matter.

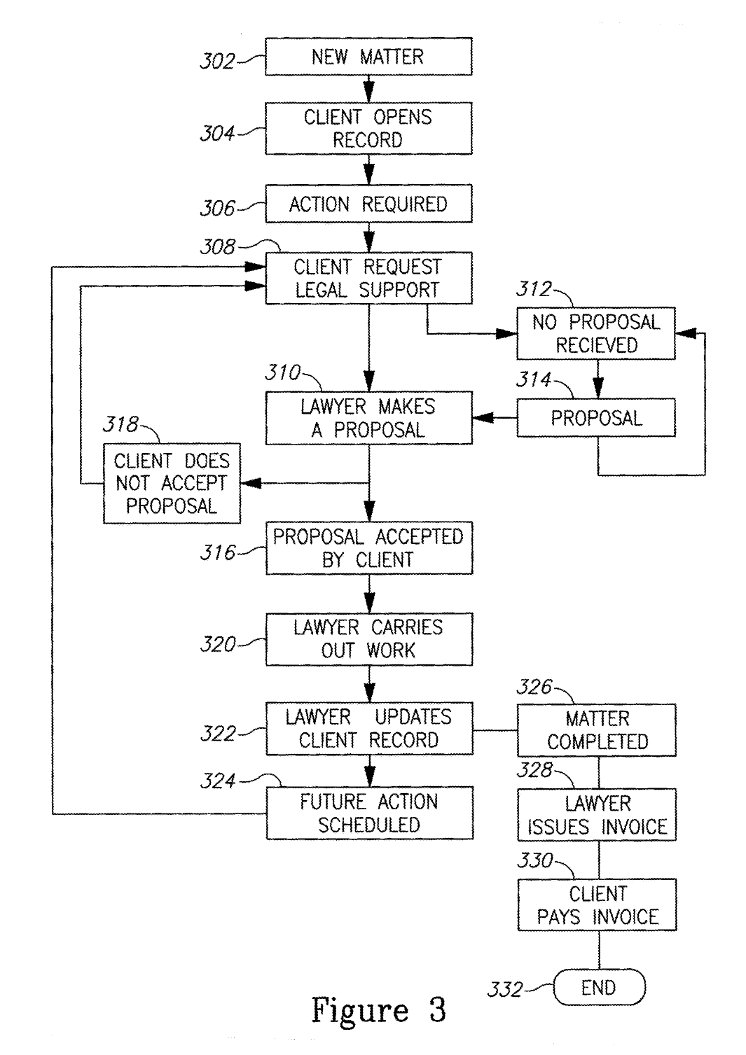

Referring to FIG. 3, a method for using the system for the provision and use of professional services is described. An important feature of this embodiment of the present invention is that the file or record relating to the matter in hand is controlled and owned by the client rather than by a legal services provider or lawyer. This is an important difference between the previously existing provision and use of legal services. By making the file the property of the client, the client has greater control over the matter and the person or persons that provide services. FIG. 3 shows a flowchart of a typical process running on the system 100 in accordance with an embodiment of the present invention.

In the first instance a new matter is identified 302 and the client opens a file or record within the MSP 304. At a certain time in the future, an action is required 306. The client or the system requests provision of legal support or services from any user of the system 308. Any providers of legal services that are interested in the matter will be notified by the system and the lawyer or legal service provider will make a proposal in respect of the matter 310. In the event that no proposal is received 312 the system will relaunch the request for legal support services 314. The relaunch of the request will continue until a proposal is received. Once a proposal has been received, the client may accept the proposal 316 or may reject the proposal 318. If the client rejects the proposal a further request for legal support 308 may be made. Once the proposal has been accepted by the client the legal services provider will carry out the necessary work 320. The legal services provider will then update the client file or record taking into account the work that has been carried out 322. If future actions or events are required the legal services provider will schedule the actions or events in the client file 324. This update will be made in the action required fields and entered into an appropriate reminder system. The future actions or events will cause the generation of a further client request 308 in due course before the due date of the future actions or events required. If the work carried out on the file concludes the matter 326, the legal services provider will issue an invoice 328 and the client will pay the invoice 330. At this point the matter ends 332.

The request for assistance may include details of the action required, a deadline for the work, a deadline for a reply to the client, any papers associated with the matter that would be needed to enable the legal services provider to make a proposal for the work, etc.

The proposal from the legal services provider may include a statement of works including suggestions of the way to proceed with the action, a timetable for dealing with the matter, an indication of any input that may be required from other parties or other legal services providers, cost and fees, etc.

It will be appreciated that the invoice and payment processes will also occur if future actions or events are scheduled and may occur at different points along the timeline of the matter depending on the relationship between the client and the legal services provider.

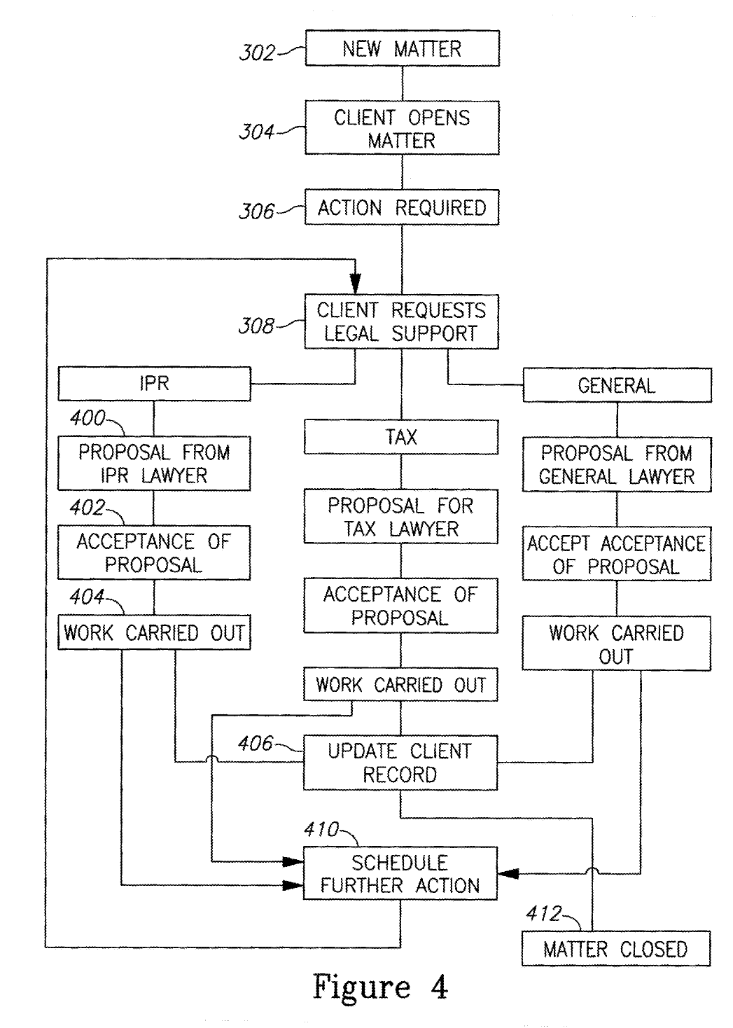

FIG. 3 shows a simple matter in which only one legal services provider is required, where a more complex matter is anticipated the process will be substantially similar but multiplied by the appropriate number of legal services providers. An example of a more complicated matter is shown in FIG. 4.

Similar elements are given the same reference number as FIG. 3. It will further be appreciated for ease of understanding FIG. 4 not all the elements and stages shown in FIG. 3 are included, although in practice they will be present.

A new matter is identified 302 and a file or record is opened by the client 304 in the system 100. The client or system identifies that an action is required 306 and that the file requires input 308 from legal services providers relating to intellectual property rights, tax and general matters. The system requests support from legal services providers in each of these fields. The process for each field (IPR, tax and general matters) is identical and only the process with respect to IPR will be described. A request for assistance is sent by the client or the system 308 and a proposal from an IP lawyer is received 400 in response to client requests for legal support 308. Once a proposal has been accepted by the client 402, the IP lawyer will carry out the work 404. The IP lawyer will update the client file 406 and where necessary schedule future actions or events 410. When the IP lawyer updates the client file. If no further actions or events are required the matter is closed 412 as described above.

Similar processes to that described with respect to the IPR are carried out in the tax and general matters fields. All lawyers or legal services providers from all fields update the client file or record and the schedule for future actions in accordance with their respective permissions. The lawyers or legal service providers can see the updates made by other lawyers or legal service providers where this complies with the permissions therefore ensuring a seamless communication of all information relating to the matter between the legal service providers.

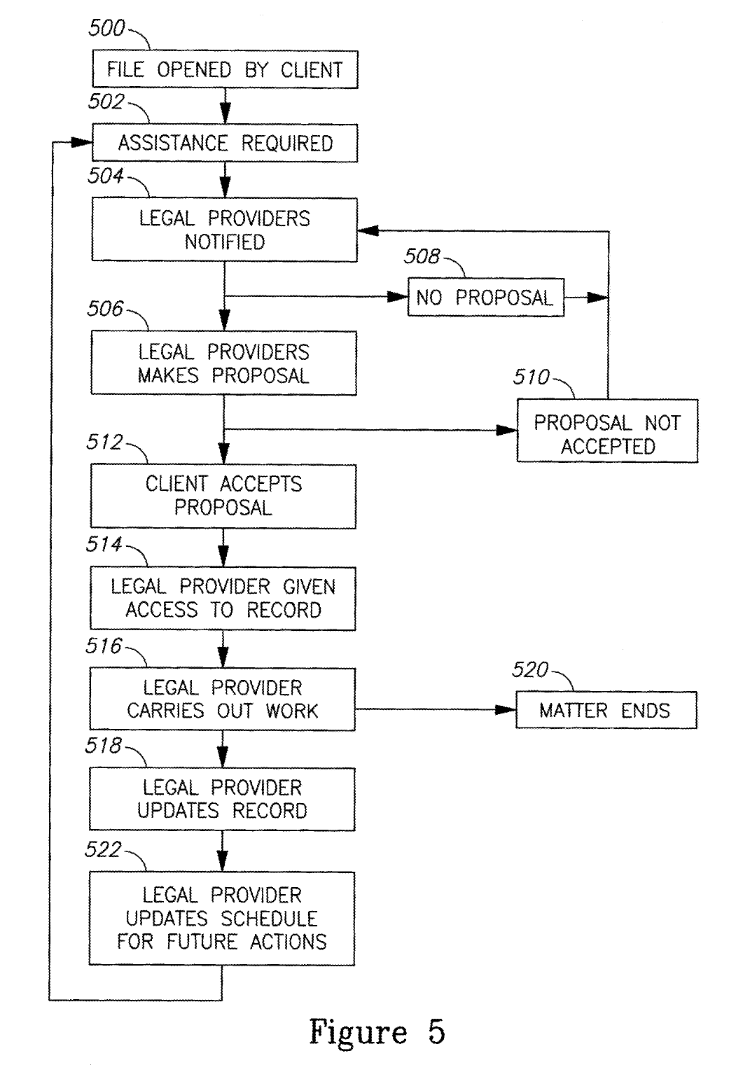

FIG. 5 shows the process from the point of view of the legal services providers. A file or record is opened by a client 500 on system 100. The system or client identifies the need for a required action and a request for assistance is issued 502. All appropriate legal service providers are notified of the action that is required 504. The relevant legal providers may make a proposal 506. If no proposal are received 508, a new notification is issued. If the proposal is received and not accepted by the client the 510 the notification for proposals is resent. If the client accepts the proposal 512 the legal services provider is given the necessary permissions to access the record or file 514 so that the legal services provider can carry out the work 516. The legal services provider then updates the record in accordance with his or her permissions 518. If there are no further actions required the matter ends 520. If there are further actions required the legal services provider updates the schedule to indicate the timescales and nature of the further actions 522 and at an appropriate time a request for further assistance 502 is launched.

A proposal may include information relating to the tasks anticipated by the legal services provider in relation to completing the required action. In addition the service provider may indicate additional services that may be required and where those services may be sought. The proposal will include a quote and a time scale for completing the necessary tasks.

The system may include a number of different templates associated with each of the actions. These templates may be used to guide the legal service providers into the type of tasks that are required to satisfy the action. The templates may also include standard letters, standard actions for a specific situation, details of the deadlines for certain actions, and any other information germane to the situation in question.

Scheduled events may automatically generate requests for the provision of services or this function may be carried out manually by a user or administrator of the system. Scheduled events may be stored within a diary system and may be entered manually or automatically. The deadlines for the scheduled events may include advanced dates for reminders and follow up requests for information. A distinction is made between a definitive deadline and a less significant deadline such as a reminder.

Where multiple legal service providers are required for a particular matter or for an action the system may generate a project which indicates who is responsible for what tasks within the action. The generation of such projects may be made on the basis of historical data stored within the system or may be based on legal statute or other rules and regulations which control the timing and actions required for a specific matter.

The system may accumulate and analyze historic data relating to a specific type of matter. This historic data may then be used for future similar matters. The historic data may include details such as required task, deadline, service providers who have previously provided assistance on such matters, costs etc. The historical data may also include future actions which are to be predicted for such a matter. It is important to note that historical data will not include any client related data but merely be generic information relating to the matter. For example the costs may not be the specific costs offered by one legal service provider to a client but instead an average cost for that type of matter.

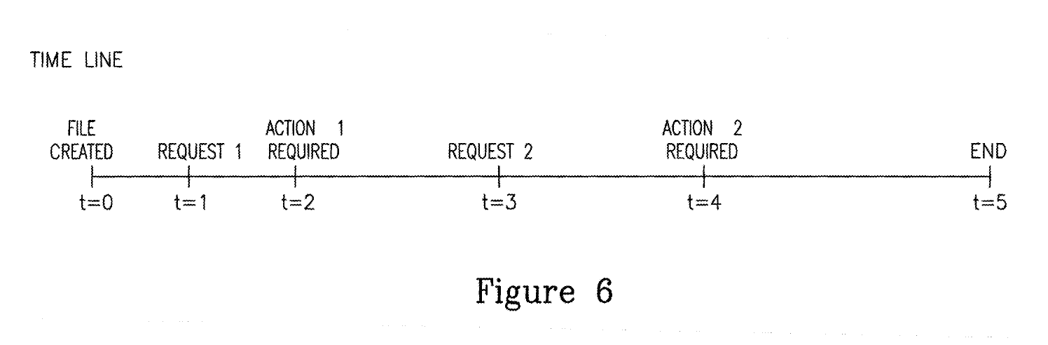

FIG. 6 shows a time line of an example matter. In the first instance t=0 a file is created. The file has two actions that are required: action 1 at t=2 and action 2 at t=4. The system or client determines the timescale for these two actions or events. The system may do this automatically by looking at previous examples of similar actions to determine the time taken to complete such an action or may use some other means of determining the length of time needed to complete the action. The client may do this by means of rules built into the permissions and system according to their own requirements in relation to the matter. In either circumstance the system generates a request for assistance related to both actions or events. For action 1, request 1 is generated at t=1 and for action 2, requests 2 is generated at t=3. The time made available to the legal services provider depends on the nature of the action as can be seen from FIG. 6. In this case action 1 requires less time to complete than action 2. Once all the actions have been attended to the matter ends at t=5.

In order to interact with the system according to an embodiment of the present invention, the client and/or legal services providers need to have access to the data relating to the matter in question. In addition, in accordance with their various permissions, the client and the legal services providers need to be able to enter new information, update schedules and indicate when work has been completed or is required to be done. The system may further be required to generate reports, manage a plurality of matters that are interrelated or not and to generally enable management of all matters belonging to a specific client.

As previously indicated or each matter there may be one or more actions or events that are associated with the matter. Each action or event may need to be completed by user (for example, a legal services provider) of the system and may need to be completed by a predetermined deadline. There may be more than one user required to carry out a task associated with the action or event and there may be multiple deadlines for the action or event. Some of the deadlines may be more important than others. For example, a reminder has less importance than a statutory deadline. The following description sets out inventive features relating to actions and events that are managed and controlled by the system. For simplicity reference is made to an action although this encompasses any act, event or task that is required to be done with respect to a matter.

For each action one or more users are required to complete tasks within one or more deadlines. Although there may be multiple users associated with an action one of the users will be the “owner” of the action. That user will be the user ultimately responsible for ensuring that the action is completed. Other users associated with the action are sub-users, which are responsible for tasks within the action but are not responsible to the whole action. The sub-users may be given permissions to enter the record associate with the action. The permissions may be controlled by the owner of the action or by the client whose matter the action is related to. The permissions may give full or partial access to the record.

The sub-user will attend to their task or part of the action and once completed will either update the record (subject to permissions) and/or will advise the owner of the action of the results so that the owner can advance the action and update the record. Where there are multiple sub-users, each will attend to their tasks and update the record and/or advise the owner of the action. The owner will use the sub-users inputs and complete the action. The owner will then update the record and close the action. Further scheduled actions will be entered and reminder deadlines will be entered as required.

In the provision of legal services there is often a reoccurrence of the same actions for different clients, matters and/or service providers. The present invention attempts to take advantage of the repetitive nature of legal services to provide a number of inventive features which address issues associated with the provision of services, such as legal services.

One such feature is the use of templates. For a specific action there are often the same tasks which are to be carried out. As a result it is possible to determine templates for a specific action. Theses templates may comprise documents, forms, instructions, deadline, pricing details, details of service providers, details of sub-users, statutory requirements, client requirements, and any other appropriate information which is germane to the completion of an action. The templates may form part of the record associated with the matter or may be stored in an alternative location and may be access as required. There may be multiple templates which are relevant to a specific matter, the relevant one can be called on at the appropriate point in the progression of the matter. The future templates may be associated with newly scheduled actions associated with the matter and may “pop-up” when reminders for newly scheduled events are notified to a user.

Where more than one user is involved in a matter or an action the users can communicate with one another through the record. This ensures that all relevant information is stored in the record and as such is available to all users depending on their permissions. As previously indicated this is a great advantage for all users as everyone is aware and has access to all facts associated with the matter without needing to access information from third parties, the client or other providers when they are assigned actions or tasks. In addition a number of actions can run concurrently with a constant update of all poignant information between the users occupied with different actions.

The system may be used by many users and clients and may be associated with a number of different matters. However, there are many matters which will occur again and again, for different clients, different records etc. In order to identify matters which are similar the system may include a field which identifies the nature of the matter, such as a code or reference number. Each matters which has the same code or number being similar. By using a reference to identify similar matters the system can be used to identify trends and statistics which can be used by the client to ensure that they are getting the best service for a specific matter or action. The system can learn the optimal way of attending to a particular action or matter and advise users of the same. Any type of data analysis may be carried out on the record, event, matter or whatever to determine information which may be used by the user to select services and find the optimal provider for these.

An example of how the learning process of the system can be helpful is as follows. If a house is being sold and a survey is required, the client can determine from the system all relevant information relating to a house survey. This may include costs, timescales, what is required, who are good suppliers of such services, who are not, the required documents, the outcome, etc. The client can use this information in accessing any proposal from a potential service provider so that the client can obtain the best service. The client may also use this information to request a change in the proposal from a service provider if the client is not convinced that the services provider is offering the best opportunities.

In another example a patent official action may be the relevant action for a patent application pending in USA (the matter). The statistical information provided by the system may include costs, preferred templates, timescales, likelihood of success (based on previous applications in the same position), expected next action and associated timescales, or any other relevant information.

The self-learning feature of the system continues to develop and grow with the creation of each new matter, action, task or deadline. There is no limit to the types of matter which can be stored and used to guide clients to the best service, best provider and best costs for a specific task, action or matter. As previously noted the system may only present to client's information of a generic nature and not any client specific information in order to preserve the confidential nature of any information which should be so treated.

As previously noted the system includes a diary system which monitors deadlines and provides reminders and the like. The reminders are generated based on rules which indicate the expected timescales for completing a specific action. These rules can be generated based on user input, trends, statutes and/or client requirements. Generally the system may be designed to present a user with a reminder list of forthcoming deadlines for matters or action. The reminder lists will typically be based on the dates of the future events and will be presented in chronological order. Deadlines may be reminder dates, intermediate dates or so called definitive dates. A definitive date is one by which an action must be completed.

In a further embodiment of the present invention the order of any deadlines may be rearranged in accordance with one or more rules. For example, the deadlines may be placed in a reminder list based on something other than chronological order. For example if a user is planning to take a vacation a list of definitive deadlines may be generated which covers the vacation period. In this way the user is able to plan the completion of any definitive deadlines during the vacation period in good time before departing. The fact that the deadlines can be ordered according to user generated rules offers a flexible deadline management process for the users.

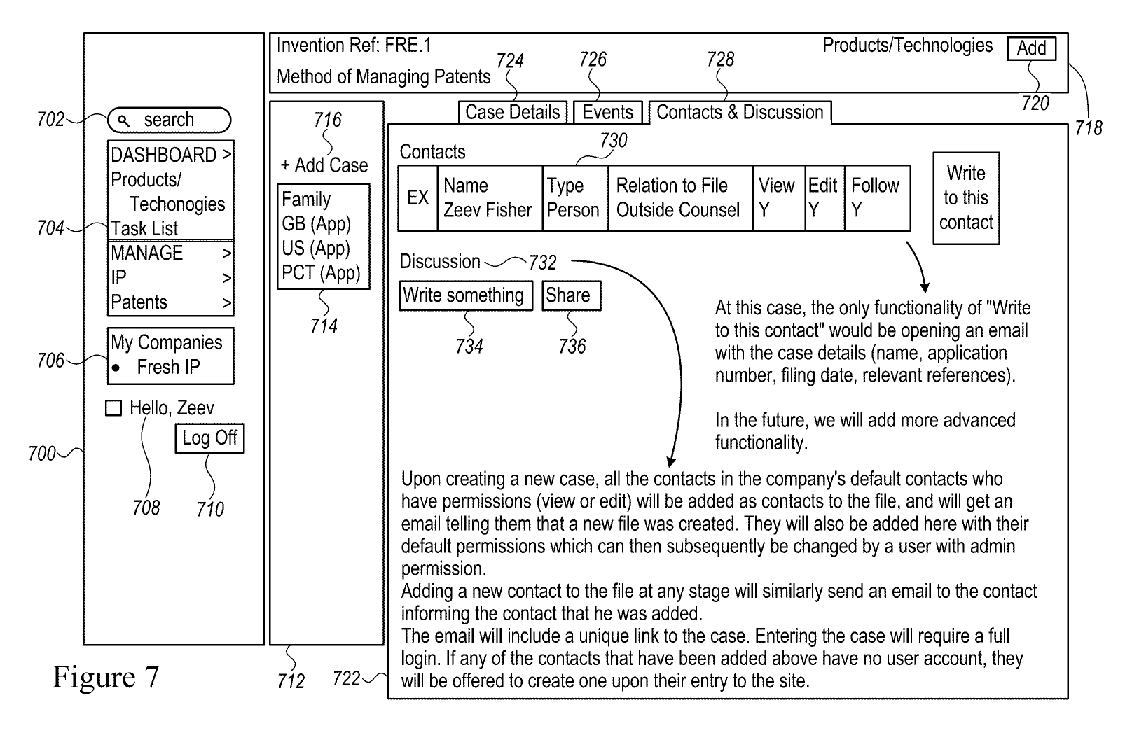

FIG. 7 shows a screenshot to show the presentation of information within the system and to indicate how information is added to various fields within the system by various parties. The screenshot includes a number of different areas. In a first area 700 there is a search window 702, the dashboard 704, a list of client names 706, messages 708 and a logoff button 710. In the second area 712 there is a list of families for a specific file or record 714. There is also a button for adding a new matter entitled add case 716. In a third area 718 reference numbers and title are shown along with additional information relating to the case which can be added using the button 720.

In the main area 722 there are a number of different tabs: case details 724, events 726, contacts and discussions 728. There may be other tabs along the length of this area depending on the nature of the record. In the example shown the contacts and discussion tab is shown as open. This tab includes contact details 730 and discussions relating to the file or record 732. In addition a window is available 734 to enter further information which can be uploaded by pressing the share button 736.

It will be appreciated there are many different examples of screenshot that may be available depending on the nature of the system, the matters concerned and the number of parameters which were both user or system controlled. There is no limit to the number of different fields and areas that can be included in a screenshot.

According to an aspect of the present invention there is provided a method of facilitating the completion of an action required for a matter, wherein the matter relates to a client and is being handled by one or more users providing a service to the client and the action includes one or more tasks; the method comprising; creating a record associated with the action in a data storage module; allocating permissions to a user to access some or all of the record to enable the user to carry out one or more tasks; on completion of a task, updating the record in accordance with permissions of the user that has carried out the task; wherein one user is the owner of the action and is responsible for giving permissions to any other user to carry out one or more tasks.

An implementation may further comprise automatically identifying a deadline for completing the tasks or action and storing the same in the record.

An implementation may further comprise identifying a requirement for completing the tasks or action and storing the same in the record.

An implementation may further comprise identifying template for use in the completion of the tasks or action and storing the same in the record.

According to an aspect of the present invention there is provided a method of using a system for managing the providing services to identify trends and statistics which are accessible by a client to enable the client to identify the optimal service of a specific matter; in a system for managing the provision of services, storing a record relating to a matter, wherein the record, includes data associated with the matter; identifying data which can be shared with a third party, based on a rule; for a type of matter identifying a plurality of records associated with such type of matter; collecting data from all identified records to determine one or more trend or statistic relating to the specific matter; presenting the data, trends or statistics to the client to enable the client to select future services through the system.

According to an aspect of the present invention there is provided a method of ordering deadlines for a user of a system for managing the provision of services, wherein the user has a list of future deadlines relating to a matter and the list of deadlines has different types of deadline, the method comprising: entering a deadline associated with the matter, the deadline including at least a date and a type of deadline; generating rules which order the deadlines of the user in a predetermined manner; wherein at a first time the deadlines are ordered in a first predetermined manner and at a second time the deadlines are ordered in a different predetermined manner.

According to an aspect of the present invention there is provided a method of facilitating the provision of professional services to a client for a matter, wherein the client and one or more service providers are users of a system for facilitating the provision of said services and the controller of said matter, the method comprising: creating a data record relating to the matter; setting client defined access permissions for the matter to grant predetermined access to the data record to the one or more service providers; determining a need for an action to be carried out in respect of the matter; requesting from the one or more service providers the provision of services to attend to the action; granting permission to one of said one or more service providers to access the data record in accordance with the predetermined access and to attend to the action.

The present invention includes embodiments which include a combination of hardware module and software routines. It will be appreciated that any combination of hardware and software may be used to implement the functionality of the embodiments and the invention is not limited to the specific examples included herein.

Although the present technology has been described in detail for the purpose of illustration, based on what is currently considered to be the most practical and preferred implementations, it is to be understood that such detail is solely for that purpose and that the technology is not limited to the disclosed implementations. On the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for managing an event-based data storage and analysis system; the method comprising: creating a record in a data storage module, wherein the record relates to a matter; creating and storing in the record one or more events relating to the matter; storing data in the record by associating the data with one or more events, wherein the or each event can be chosen from a predetermined list of events relating to the type of the matter; and analyzing data collected for a type of event for one or more matters to determine information relating to the type of event.

2. The method of claim 1 further comprising storing the information for future use.

3. The method of claim 1 wherein the analyzing step further comprises identifying information associated with the type of event, such as statistical data relating to the type of event; timescales associated with the type of event; and costs and fees associated with type of event.

4. The method of claim 1 wherein the analyzing step further comprises identifying trends relating to the type of event, by comparing information relating to said event to a benchmark derived from analyzing multiple similar events.

5. The method of claim 1 wherein the analyzing step further comprises evaluating performance of users in relation to said events, by way of comparing the efficiency of a user in performing tasks related to the event to a benchmark derived from analyzing multiple users performance

6. The method of claim 1, further comprising controlling access to the record by granting permissions to one or more users to access data associated with an event; wherein the method comprises: granting first permissions to a first user to access first data in the record; granting, by the first user, second permissions to a second user to access second data in the record.

7. The method of claim 1, wherein the storing one or more events includes storing a date for the event, and details of the event.

8. The method of claim 1, further comprising creating a project associated to at least one record or event, wherein a project includes at least a due date, a description of the project, and at least one task associated with the project, wherein said task is associated with at least one user.

9. The method of claim 8, wherein the project can be created based on a project template previously created in relation to a response to the event.

10. The method of claim 9, wherein the project template is created by a system administrator and provided to the or each users, wherein the or each user can change the templates.

11. The method of claim 10, wherein the system administrator defines an association between a template and a type of user, wherein user types can be a consumer of services, a provider of services, or a third party.

12. The method of claim 8, wherein a project is automatically created, based on a predetermined project template, and automatically launched upon occurrence of a particular event.

13. The method of claim 12, wherein a user is prompted to decide whether to create a project associated to an event based on a project template.

14. The method of claim 1, further comprising storing files associated with at least one record, event, or project wherein the first user and the second user communicate on matters related to the record, the event, the project or any combination thereof, and said communications are stored with an indication that they are associated to the record, the event, the project, or any combination thereof.

15. The method of claim 1, further comprising creating cost records associated with at least one record, event, or project, wherein said cost record include financial information on money that has been transferred, needs to be transferred or will be transferred between the first user and either the second user or a third party.

16. The method of claim 15, further comprising a first user requesting a quotation, wherein the quotation is associated with a record, an event, a project or any combination thereof and is communicated to at least one of the second user or a third party; wherein, the at least one of the second user or a third party respond by providing a quote and the first party is automatically informed that quotation has been provided; and wherein the first user indicates acceptance or rejection of the quotation.

17. The method of claim 16, wherein said indication by the first user creates at least one record of a cost or project.

18. The method of claim 16, wherein first and second users communicate on matters related to the record, the project, the cost, the quotation, the event, or any combination thereof, and said communications are automatically stored with an indication that they are associated with the record, the project, the cost, the quotation, the event, or any combination thereof.

19. An event-based data storage and analysis system for managing event-based data storage and analysis; the system comprising: a data storage module in which a record is created and in which one or more events relating to a matter are created and stored; and wherein data is stored in the record by associating the data with one or more events, wherein the or each event can be chosen from a predetermined list of events relating to the type of the matter; and an analysis module for analyzing data collected for a type of event for one or more matters to determine information relating to the type of event.

20. The system of claim 19 further comprising a storage module for storing the information for future use.
